(19) United States
(12) Patent Application Publication
(10) Pub. No.: US 2009/0082241 A1
(43) Pub. Date: Mar. 26, 2009

(54) SWEEPING COMPOUND

(75) Inventor: KENNETH C. OSSIAN, Bettendorf, IA (US)

Correspondence Address: MCKEE, VOORHEES & SEASE, P.L.C., 801 GRAND AVENUE, SUITE 3200, DES MOINES, IA, 50309-2721, US

(73) Assignee: OSSIAN, INC., Davenport, IA (US)

(21) Appl. No.: 11/861,039

(22) Filed: Sep. 25, 2007

(51) Int. Cl. C09K 3/22

(52) U.S. Cl. 510/216

(57) ABSTRACT

Floor sweeping compositions that replace refinery oil with a liquid mixture of alkali and/or alkaline earth salts with glycerin, all in combination with a moisture holding carrier.

### BACKGROUND OF THE INVENTION

This invention relates to compositions of a type used as floor sweeping compounds. Floor sweeping compounds are of course age-old. Dust control is a common problem for floor sweeping. In the past, the most effective dust control agent has been oil. Hydrocarbon oil from the oil refining process in an appropriate percentage, is simply added to the carrier composition, thus enhancing the pick up of dust. This mixture suppresses dust when sweeping and also cleans the floor.

As it has developed in the art over the years, conventional sweeping compounds include a hydrocarbon oil product that is combined with a carrier and perhaps, other cleaning and disinfecting aids. The oil is usually bottoms residue obtainable from refineries hereinafter referred to as “refinery oil”.

Carriers such as sawdust, rice hulls, oat hulls, corncobs and sand have been used for years as a medium to which the oil product adheres. The sand, when used, functions as both a carrier and abrading cleaner, and a weighting compound to assure that the sweeping composition will “hug” the floor. Variable proportions of sand are used, depending upon the age and the composition of the floor being cleaned. For example, with newly finished floors, sand in the composition is usually eliminated. However, as the floor gets older and abraded, sand is used to make sure that the composition effectively hugs the floor and causes slight abrasion to enhance cleaning.

In known sweeping compounds, the oil product fraction also functions as a non evaporating moistening agent to control dust. Hydrocarbon oil therefore serves two important functions, dust suppression and enhanced dirt pickup. Unfortunately refining oil in the sweeping compounds also has the ability to damage certain flooring materials, or at least the finish of some flooring materials. Further, refinery oil is expensive. It also has the additional disadvantage of being a fire hazard and an environmental pollutant. Disposal of refinery oil based sweeping compounds may therefore be difficult in the future. As a result, there is a continuing need for development of effective sweeping compositions which avoid the inherent problems of a refinery oil additive, or a least reduce the oil content, but at the same time, still provide the effective dust control and enhanced dirt pickup normally associated with refinery bottoms oil use.

In commonly owned U.S. Pat. No. 5,397,492 issued Mar. 14, 1995, we introduced a floor sweeping composition including a floor sweeping solid carrier and a liquid hygroscopic alkali or alkaline earth salt solution, preferably selected from the group of magnesium chloride and calcium chloride. The liquid enhances the effectiveness of the sweeping composition and its ability to collect and remove fine dust materials.

In our original sweeping composition U.S. Pat. No. 5,397,492, we were able to improve product performance but still encountered some difficulty with forming a uniform mix. The hygroscopic solutions of both calcium and magnesium chloride would tend to ball and form lumps in the mixture. This problem could be solved by reducing the amount of fluid used but doing so also reduced the dust pick up of the finished product.

In this present invention we have addressed this issue of the inherent disadvantages of refinery oil by increasing the viscosity of the liquid calcium chloride and/or magnesium chloride with the addition of glycerin. By altering the viscosity of our previously patented composition to that of typical refinery oil used in sweeping compound by adding glycerin, a more uniform mix is achieved, and the advantages of refinery oil without the attendant disadvantages are obtained.

Glycerin is available in large amounts as a by-product from one or more of saponification, hydrolysis and transesterification reactions with triglycerides for the purpose of producing products such as soaps and fatty acids and bio-diesel. There is moreover a current glut of glycerin on the market and people are searching for additional uses. This invention does provide a new alternative use for glycerin.

A primary object of the present invention is to provide an effective floor sweeping composition which either does not use refinery oil at all or incorporates refinery oil at reduced levels as a dust control agent.

Another primary objective of the present invention is to provide a floor sweeping composition of enhanced sweeping capability and of highly effective dust control, which remains stable over a wide range of temperatures conditions, from below freezing to as much as 100° F.

Yet another objective of the present invention is to provide a floor sweeping composition which can be conveniently packaged, shipped and stored, and which will remain stable during this entire time.

Another objective of the present invention is to provide a floor sweeping composition for effective dust control which provides maximum flexibility in that the dust control agent is effective where the floor composition ranges from no sand up to as much as 80% to 90% sand.

A yet further objective of the present invention is to provide a floor sweeping composition which has at least comparable dust control capability in comparison with refinery oil, and can be disposed of without environmental restrictions.

Another objective of the present invention is to provide a floor sweeping composition that is less expensive to produce than those which use refinery oil as a dust control agent.

A still further object of the present invention is to provide a floor sweeping composition that is safe to use with various flooring materials without damage to the floor or its finish.

And, another object is to find a new use for by-product glycerin which is currently flooding the U.S. market due to the popularity of biodiesel fuel.

Other objects, advantages and novel features of the present invention will become apparent from the following description of the invention.

### BRIEF SUMMARY OF THE INVENTION

A floor sweeping composition including a floor sweeping carrier capable of holding moisture and a liquid hygroscopic alkali or alkaline earth salt solution, preferably selected from the group of magnesium chloride and calcium chloride, blended with a viscosity enhancer of glycerin. The liquid enhances the effectiveness of the sweeping composition and its ability to collect and remove fine dust materials, without risk of harm to floors or the environment, normally associated with refinery oil.

### BRIEF DESCRIPTION OF THE DRAWINGS

FIG. 1 shows viscosity changes to liquid calcium chloride with various percentages of glycerin.

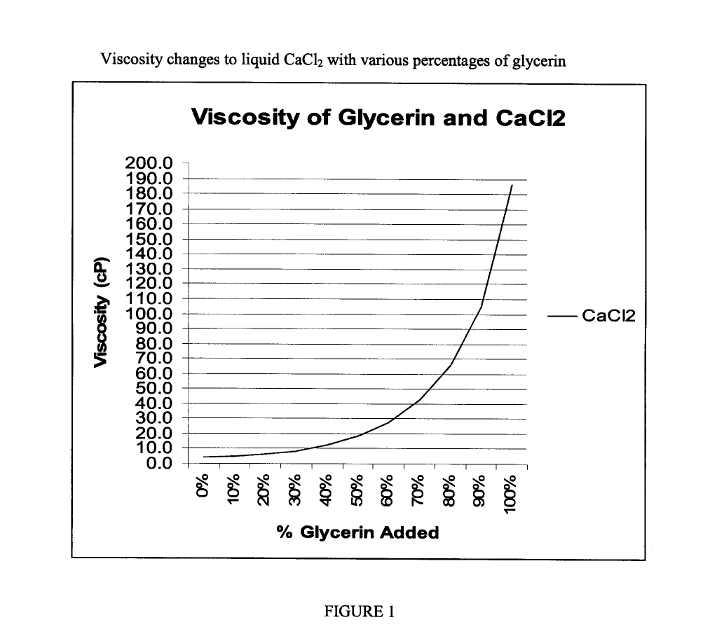

FIG. 2 is a graph similar to FIG. 1 showing viscosity changes to magnesium chloride with various percentages of glycerin.

FIG. 3 shows a bar graph from the dust collected results for the samples of the working example.

### DETAILED DESCRIPTION OF A PREFERRED EMBODIMENT

The disclosure of commonly owned U.S. Pat. No. 5,397,492 issued Mar. 14, 1995, is incorporated herein by reference, as though the same was here fully set forth.

As earlier indicated, the floor sweeping composition of the present invention uses a conventional solid carrier, at least moisture holding but preferably moisture absorbing and preferably finely divided. That carrier can be any of those known in the art as long as it meets the required physical criteria and generally can be sawdust, rice hulls, oat hulls, and variable levels of sand.

Both the sawdust and the sand can be sifted initially to provide aggregate particle size control. The preferable screen size is as follows:

| | |
|---|---|
| U.S. screen size | Retained on screen |

Sawdust

| | |
|---|---|
| 3½ | Not more than 5% |
| 10 | 30-50% |
| 14 | 10-20% |
| 30 | 20-30% |
| Pan | 20% or less |

Sand

| | |
|---|---|
| 30 | 70% or more |
| Pan | 20% or less |

Sand level in the composition is variable. For new floors, usually no sand will be used, and for older floors, up to as much as 80% or 90% sand will be used.

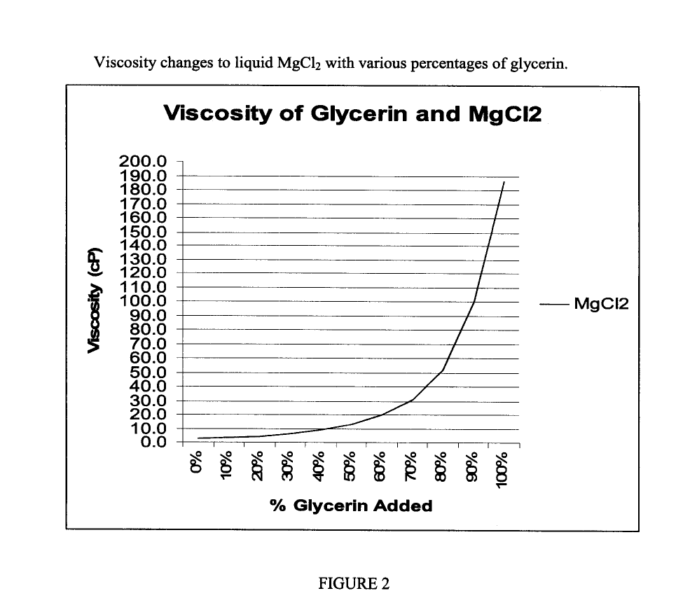

The ratios of glycerin to liquid CaCl₂ and liquid MgCl₂ can be as little as 1% or as high as 99%. Glycerin has a low freeze point and is hygroscopic and could be used by itself as a liquid solution for sweeping compound. A review of FIG. 2 would suggest a blend of approximately 50% glycerin with 50% CaCl₂ would provide similar viscosity as oil. A blend of 60% glycerin and 40% magnesium chloride would yield similar results.

The weight ratio of glycerin to the liquid CaCl₂ and/or MgCl₂ will vary over a wide range depending upon the nature of the floor sweeping composition. This range can be from 1% to 99%. Generally the weight ratio will be from 1 part glycerin to 3 parts liquid calcium and/or magnesium chloride to a range of 3 parts glycerin to 1 part liquid calcium and/or magnesium chloride. The best results for dust control are achieved with a weight ratio of 1 part glycerin to 3 part liquid CaCl₂ (32% solution) are shown below.

One skilled in the art would not normally think of by-product glycerin as a suitable replacement of refinery oil in sweeping compound for several reasons. First glycerin is hygroscopic, and one would expect the absorption of moisture by glycerin would destroy product stability. Secondly, glycerin as an alcohol is normally more chemically reactive than hydrocarbons. Third, the combination with alkali or alkaline earth chloride salts of calcium and magnesium would be expected to further destabilize as they might well react as a hydroxide base with the alcoholic functional groups of the by-product glycerin. Instead, what applicants found is that in the presence of a finely divided moisture absorbing carrier such as sawdust, and, where sand is used, since the fine particles have a high surface area, the moisture physically collects on the surface, and is there held and acts much like it has been absorbed, thus due to this combination of physical and chemical events, unexpectedly by-product glycerin works to replace hydrocarbons.

The following examples are offered to illustrate but not limit the invention. They demonstrate glycerin's effectiveness as a replacement for refinery oil that does not harm floors or the environment.

### EXAMPLES

Six samples of sweeping compounds were formulated for testing using 10 lbs of sawdust to one gallon of a dust absorbing liquid.

### Sample 1—Control

Mixture composed of 10 lbs. of sawdust to one gallon of oil.

### Sample 2

Mixture composed of 10 lbs. of sawdust to ½ gallon of 32% liquid calcium chloride and ½ gallon of glycerin (by product of bio diesel production).

### Sample 3

Mixture composed of 10 lbs. of sawdust to 1 gallon of glycerin (by product of bio diesel production).

### Sample 4

Mixture composed of 10 lbs. of sawdust to 1 gallon of 32% liquid calcium chloride.

### Sample 5

Mixture composed of 10 lbs. of sawdust to ¾ of a gallon of 32% liquid calcium chloride and ¼ gallon Glycerin (by product of bio diesel production).

### Sample 6

Mixture composed of 10 lbs. of sawdust to 9/10 of a gallon of 32% liquid calcium chloride and 1/10 of a gallon of Glycerin (by product of bio diesel production).

The equipment used in testing the six samples was a standard sieve shaker and sieves at 3½, 10, 14, 30 pan. The test procedure is below described.

For comparison purposes, Table 1 shows the viscosity in table form for typical oil refinery sweeping compounds, for sweeping compounds of our previous U.S. Pat. No. 5,397,492 and for glycerin byproduct of biodiesel, all measured with a Brookfield Viscometer at 25° C.

TABLE 1
Viscosity determined using a Brookfield Viscometer at 25° C.

| | Viscosity Value (cP) |
|---|---|
| 1. A typical oil used in sweeping compounds | 21.10 |
| 2. 32% Liquid calcium chloride | 4.19 |
| 3. 29% Liquid magnesium chloride | 2.70 |
| 4. Glycerin - by-product of bio diesel production | 186.00 |

Standard talc powder was used as the dust agent. All six samples identified above were run through a sieve shaker to check for absorbability. We next recorded the tare weight of the collection pan. 100 g of sweeping compound from each of the six samples above was placed onto a tarred 3½ sieve, making sure to cover the entire surface. Next we evenly added 300 g of talc on top of the 100 g of sweeping compound and placed the pans in stacking order: (top) 3½, 10, 14, 30, pan (bottom) on the sieve shaker and ran each test for 5 minutes. Then we weighed the collected amount of talc on the collection pan minus it's tare weight and recorded each collection that had passed through the plates within the 5 minutes testing period. Between each test, all sieves were blown clean with compressed air. Each sample was tested three times and recorded. Table 2 below shows the amount of talc collected for each sample.

TABLE 2
TALC DATA

| | Amount of Talc Collected | | | Average |
|---|---|---|---|---|
| Sample #1: | 106 | 98 | 105 | 103 |
| Sample #2: | 153 | 160 | 154 | 155.7 |
| Sample #3: | 240 | 234 | 247 | 240 |
| Sample #4: | 240 | 220 | 229 | 229.7 |
| Sample #5: | 112 | 124 | 114 | 117 |
| Sample #6: | 226 | 214 | 220 | 220 |

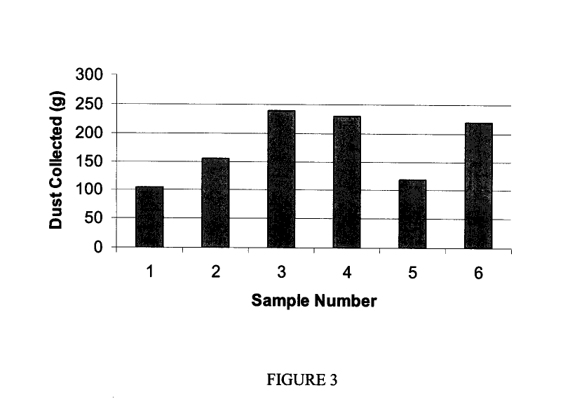

The results of Table 2 are shown in graph form in FIG. 3. Out of the six samples tested above, sample number five had the closest test result to the control sample number one. This sample was composed of 10 lbs of sawdust to ¾ gallon of 32% liquid calcium chloride and ¼ gallon of glycerin (by product of bio diesel production). Samples 2, 3, 4 and 6 exceeded the dust collection ability of the control.

The data clearly shows that liquid calcium chloride blended with various levels of Glycerin from bio diesel production can produce a viscosity similar to refinery oil and can be blended with sawdust to produce a dust absorbing mixture that can be used as sweeping compound. The mixture can be subjected to extreme temperatures from below zero and up to a 100 degrees F. and still retain its phase stability.

It can be seen that the compositions of the present invention are similar to those compositions using refining oil and in some cases it is more effective than refinery oil. It can be disposed of without providing any risk of oil contamination, and can be used to fully replace oil or greatly reduce the refinery oil content as a component of floor sweeping compositions, and yet function as effectively as refinery oil for wetting or moistening agent used to control dust.

It therefore can be seen from the foregoing description of a preferred embodiment, and from the working examples that the invention accomplishes all of its stated objectives.

1. A floor sweeping composition having stable freeze/thaw characteristics from below zero to about 100° F., comprising:
a solid moisture holding carrier component for use in enhancing the effectiveness of floor sweeping and a liquid component composed of a hygroscopic alkali or alkaline earth salt solution combined with a glycerin viscosity enhancer, said liquid component having a viscosity at or near that of typical refining oil as used in floor sweeping compositions.

2. The floor sweeping composition of claim 1 combined with some refinery oil but of reduced refinery oil levels for sweeping compositions.

3. The floor sweeping composition of claim 1 where in said solid moisture holding carrier component is selected from the group consisting of sawdust, rice hulls, oat hulls and sand.

4. The floor sweeping composition of clam 1 wherein the liquid component is composed entirely of the glycerin.

5. The floor sweeping composition of claim 1 wherein the liquid component is an alkaline earth salt solution combined with glycerin.

6. The floor sweeping composition of claim 1 wherein the viscosity enhancer glycerin is a by product of the bio diesel production.

7. The floor sweeping composition of claim 1 wherein the liquid component to be combined with the viscosity enhancer is an alkaline earth salt solution is selected from the group consisting of calcium chloride and magnesium chloride.

8. The floor sweeping composition of claim 7 wherein the salt solution is calcium chloride salt solution.

9. The floor sweeping composition of claim 8 wherein the concentration is from about 15% to 35% calcium chloride salt solution.

10. The floor sweeping composition of claim 9 wherein the concentration is about 29% to 32% calcium chloride salt solution.

11. The composition of claim 1 wherein the solid component is composed of 1 part sawdust to the one part liquid component and wherein there is 0.5 part glycerin to 2 parts glycerin to one part sawdust.

12. The composition of claim 11 wherein the preferred ratio is 1 part sawdust to 1 part glycerin.

13. The composition of claim 1 wherein the liquid component is liquid calcium chloride combined with glycerin as a viscosity enhancer with the ratio can range of from 1 part to 99 parts glycerin to 99 parts to 1 part liquid calcium chloride.

14. The composition of claim 13 wherein the liquid component is liquid calcium chloride combined with glycerin range of from 10 parts to 90 parts glycerin to 90 parts to 10 parts liquid calcium chloride.

15. The composition of claim 14 wherein the liquid component is liquid calcium chloride combined with glycerin at a ratio of 1 part glycerin to 3 parts liquid calcium chloride.

16. The composition of claim 15 wherein the liquid component is combined with the solid component at the ratio of 1 part sawdust to 0.5 part liquid component to 2 part liquid component.

17. The composition of claim 16 wherein the liquid component is combined with the solid component at the preferred ratio of 1 part sawdust to 1 part liquid component.
